(19) United States
(12) Patent Application Publication
(10) Pub. No.: US 2019/0191246 A1
(43) Pub. Date: Jun. 20, 2019

(54) System and Method of Intra-Speaker Network Sound Delivery

(71) Applicant: Joseph Born, Lincolnwood, IL (US)

(72) Inventor: Joseph Born, Lincolnwood, IL (US)

(73) Assignee: AIWA Corporation, Chicago, IL (US)

(21) Appl. No.: 15/841,858

(22) Filed: Dec. 14, 2017

(51) Int. Cl. H04R 3/12; H04R 5/04; H04R 5/033; H04R 5/02

(52) U.S. Cl. CPC H04R 3/12; H04R 5/04; H04W 4/80; H04R 5/02; H04R 5/033

(57) ABSTRACT

A system for delivering sound that includes portable wireless speakers or wireless headphones that connect with a smart mobile device using short range communication. Each speaker is also able to connect wirelessly to other speakers. The collection of these connections form an intra-speaker peer-to-peer network. Within the network there can be one or more audio broadcasts provided by one or more smartphones or other mobile devices. Some speakers have phones connected to them and some speakers do not. Speakers may be tuned to play different content being broadcast from other speakers that are streaming content from smartphones. The invention provides a user interface that allows a user to easily and intuitively navigate through the numerous connection possibilities. The invention also makes connecting to the ad hoc mobile network or switching between different audio streams within the network as intuitive and simple as possible for users.

### BACKGROUND

### Field of the Invention

The present invention relates generally to the field of wireless sound delivery such as wireless loudspeakers or earphones and more particularly to a system and method for intra-speaker networking and sound delivery.

### Description of the Problem Solved

Wireless audio speakers and headphones are well known. These connect with a host such as a smartphone, typically via BLUETOOTH™ or Wifi. Both of these local radio techniques is in almost universal usage. Also well known are speakers that connect with multiple peers. Examples include the Aiwa Exos 9 which connects with two speakers and many others. Also in use are speakers commonly known as multi-room audio typically using WiFi to connect to many speakers throughout a home or other building. These include Sonos and Denon Heos and others.

Such multi room systems have developed a variety of tools that are used for coordinating the playback of a relatively large number of speakers, but at the expense of simplicity (they require access and connection to a wifi access point, the installation of an app, and the setting up of zones etc.).

None of these systems is suitable for more flexible ad hoc connections as may be desired for connecting multiple speakers outside the home. What is badly needed is a system that will allow users to simply and easily connect multiple speakers without requiring control from a smartphone or tablet, and without connecting to an access point with other setup procedures requiring a separate device (beyond the speakers itself). In addition, it would be very advantageous for such dynamic systems to include a mesh network that can be flexible, dynamic and can extend the range of the original source.

### SUMMARY OF THE INVENTION

The present invention relates to a system of portable wireless speakers or wireless headphones that typically connects with a smartphone or tablet using a short range communication technique such as BLUETOOTH(TH) or WiFi and is typically battery powered. In addition to the wireless connection between the smartphone and the speaker, each speaker is also able to connect wirelessly to other speakers. Taken as a group, the collection of these connections form an intra-speaker peer-to-peer network. Within the intra-speaker network there can be one or more audio broadcasts provided by one or more smartphones. Some speakers in such a network have individual phones connected to them and some speakers do not. Speakers can be tuned to choose between the various audio content being broadcast. Such a network creates a myriad of possibilities of connections between speakers and other speakers, and between speakers and smartphones. This can lead to conflicts between those connections.

An object of the present invention is to provide a user interface that allows a user to easily and intuitively navigate through the numerous connection possibilities.

A further object of the invention is to make connecting to the ad hoc mobile network or switching between different audio streams within the network as intuitive and simple as possible for users.

### DESCRIPTION OF THE FIGURES

Attention is now directed to several figures that illustrate features of the invention.

FIG. 1 shows a block diagram of a speaker.

FIG. 2 shows a block diagram of a peer-to-peer speaker network.

FIG. 3 shows a speaker control state chart.

FIG. 4 shows control button sensitive to gestures.

FIG. 5 shows a mechanical button.

FIG. 6 shows a phone-lock switch.

FIG. 7 shows a phone display.

Several figures have been presented that aid in understanding the present invention. The scope of the present invention is not limited to what is shown in the figures.

### DESCRIPTION OF THE PREFERRED EMBODIMENT

The present invention relates to a system and method of intra-speaker network sound delivery. The invention includes a wireless speaker that has capability to connect to a smartphone or other smart device and, in addition, has capability to connect and communicate with another similar peer speaker. The present invention thus includes a peer-to-peer wireless network with the ability for a user to easily resolve conflicts, to direct sound or music from a particular source to particular speakers, and to change the configuration of the network without having to perform a complicated setup procedure. The connection between a smartphone and a speaker will be referred to as a phone-speaker connection. The connection between a speaker and another speaker will be referred to as a intra-speaker connection.

The term “speaker” herein used refers to any device capable of converting an electrical signal to audible sound including loudspeakers and headphones. The wireless network can be any wireless technology with short-range radio techniques such as BLUETOOTH™ and WiFi being preferred. The term “smartphone” as used herein means a cellular telephone, a tablet computer, a laptop computer, a desk or tower computer, or any other computing or electronic device that has communication capability. The term “directly” means connection between two speakers or a speaker and a smartphone without the use of an access point.

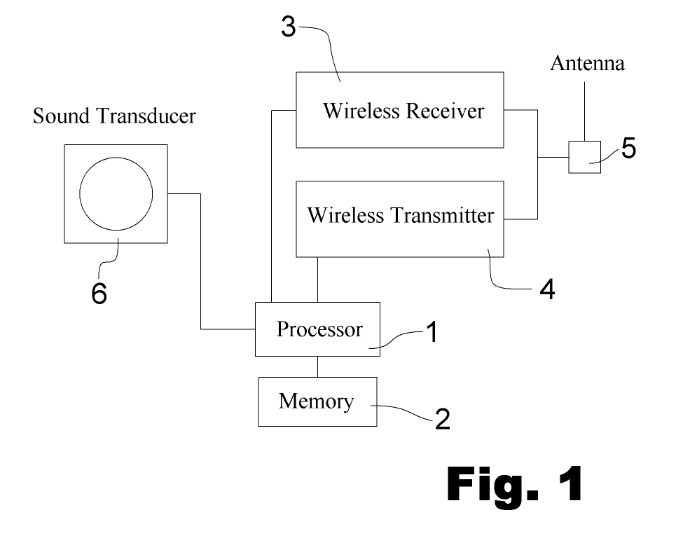

The basic unit of the present invention is a wireless speaker as shown in FIG. 1. This wireless speaker contains a processor 1 with memory 2 executing a stored program. The speaker also contains one or more wireless communication modules, that include a wireless receiver 3 and a wireless transmitter 4. These are in turn coupled electrically to an antenna 5. A typical speaker may contain a BLUETOOTH™ capability, a WiFi capability, or both (or it may include any other wireless communication capability). The speaker also contains a sound transducer 6 that converts electrical signals to audible sound. Streaming audio data is digitized and typically compressed. The processor 1 using the memory 2 de-compresses the streamed data and converts it to an analog electrical signal using a digital to analog converter (not shown). This entire process can be performed by the processor 1, or external hardware may be used. The speaker typically has the capability to link into an existing network or to act as a master and form a new network. The interface to the user from the speaker is in the form of one or more buttons or controls mounted on the speaker along with visual and/or audio cues.

A feature of the present invention is that speakers communicate directly with smartphones and directly with one-another. As previously stated, by “directly”, I mean that they do not need to communicate through an access point. The term “directly” only refers to point-to-point communication between network nodes; it does not rule out higher level communication peer-to-peer through multiple network nodes. Because the speakers can form a peer-to-peer network, in some embodiments, content can be relayed from speaker to speaker and finally converted to audible sound by a speaker several nodes removed from the speaker that is streaming the content from the smartphone. This type of communication is within the scope of the present invention. In the most general case, the peer-to-peer network can include the ability of any of the speakers to communicate with any other speaker (generally through intermediate nodes that in turn communication directly with each other).

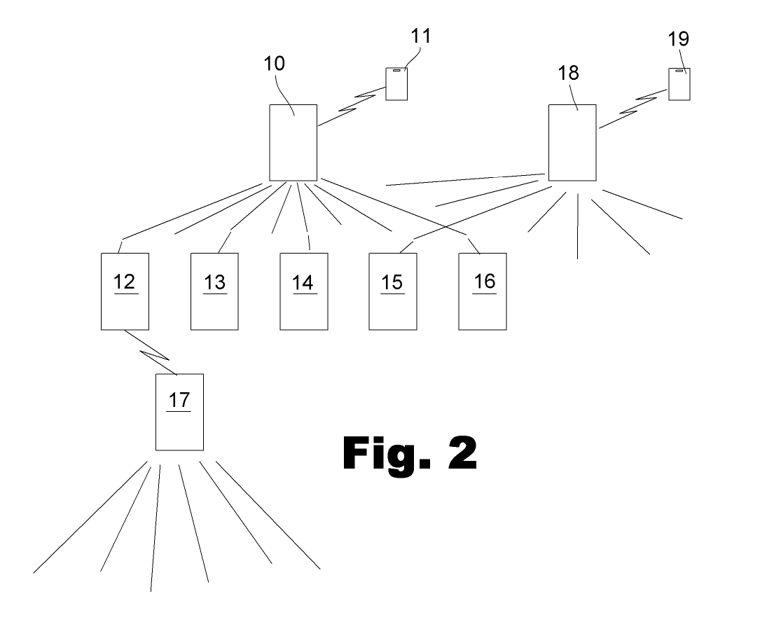

Thus, a peer-to-peer network can be formed from speakers with a group of speakers paired with a group of smartphones, each streaming a different audio content from the smartphone such as shown in FIG. 2. Here a speaker 10 in transmit mode receives streamed audio from a smartphone 11. It broadcasts this content. Other speakers 13, 14 and 16, operating in receive mode convert the content to auto and play it. Another speaker 18, also in transmit mode receives steamed content from another smartphone 19 and broadcasts it. Speaker 16 in FIG. 2, operating in receive mode plays that content. Any of the speakers in receive mode can be “tuned” to any station on the network in range that is broadcasting. Speaker 12 is also in wireless communication with speaker 17. In this case, speaker 12, even though in receive mode, is acting as a relay to speaker 17 which is also operating in receive mode and is playing the relayed content. However, speaker 17 could also operate in transmit mode and rebroadcast the relayed content. Thus, a speaker, even though it is in receive mode, can in some embodiments retransmit the received content to another speaker that may be out of range of the original broadcasting speaker. It should be noted that while typically, the speakers in transmit mode, namely speakers 10 and 18 in FIG. 2, are also playing the content they are receiving from their paired smartphone, this is not an absolute requirement. In fact, in some embodiments speaker 18, for example, might be playing the content being broadcast from speaker 10 that originated from smartphone 11 while simultaneously broadcasting the content from smartphone 19. In this embodiment, a speaker in transmit mode, can also be tuned to other stations in transmit mode to play their content rather than the content it is receiving.

In summary, speakers that are streaming audio can be in a transmit mode where they broadcast their particular streamed audio to other speaker devices that are in a receive mode. The speakers in transmit mode typically also convert their particular streamed audio content to audible sound. The speakers in receive mode convert whatever content they are tuned to (which ever speaker in transmit mode they are listening to) to audible sound. In some embodiments, a particular speaker in transmit mode can be playing sound that is not what that speaker is broadcasting, but rather content being received over the network from another speaker in transmit mode. Also, in some embodiments, speakers can relay to other speakers that may be out of range of a particular broadcaster.

Thus, in a typical case, there are N content streams. The content streams are 1, 2, 3, . . . N. There are M speakers, 1, 2, 3, . . . M, where N and M are positive integers and M is generally larger than N (or at least not smaller than N). A subset N of the M speakers are streaming content from N smartphones and broadcasting it in the transmit mode. The remaining M-N speakers are in the receive mode and are each receiving one of the N streams and converting it to audible sound. The N transmitting speakers are also producing audible sound. As stated, the broadcasting speakers are usually playing the same content they are broadcasting. However, in the most general case, in some embodiments of the invention, because of the nature of a peer-to-peer network, a transmitting speaker may be tuned to another speaker and playing content being broadcast by that other speaker while still broadcasting its streamed content. In addition, some speakers in receive mode may be acting as relays to other speakers in receive mode or other speakers in transmit mode.

As a concrete example, suppose that N=3, and M=6. There are 3 speakers in transmit mode streaming content from 3 different smartphones. There are 3 other speakers in receive mode that are able to tune in one of the 3 contents being broadcast and to play it. This tuning is selectable by a user at each receiving speaker. The 3 speakers in transmit mode are each playing only the content that they are broadcasting. The 3 speakers in receive mode can tune to the content they want.

In a more complex example, the numbers are the same, N=3 and M=6. Speakers 1-3 are steaming and broadcasting contents 1-3. Speaker 4 is tuned to content 1. Speakers 5 and 6 are tuned to content 2. Thus speaker 1 is playing content 1, speaker 2 is playing content 2, speaker 3 is playing content 3, speaker 4 is playing content 1, and speakers 5 and 6 are playing content 2. In one embodiment of the invention, only speakers 4-6 can be tuned to different contents. In another embodiment of the invention, any of the speakers can be tuned to any of the content. In this alternate embodiment, speaker 1 can be tuned to play content 3 while it continues to stream and broadcast content 1.

Also, in the most general case, intermediate speakers may relay broadcast content to other speakers out of range of the original broadcaster. Again, this is due to the general nature of a peer-to-peer network.

Finally, due to the mobile nature of smartphones and headphones (which are included as speaker), the network may change dynamically as things move around. For example, there may be a “handoff” from one broadcasting speaker to another speaker as a pair of headphones moves around. In the most general case, there may also be a “handoff” as a smartphone moves out of range of a broadcasting speaker where another, closer speaker takes over the streaming and broadcasting task as the smartphone moves near it.

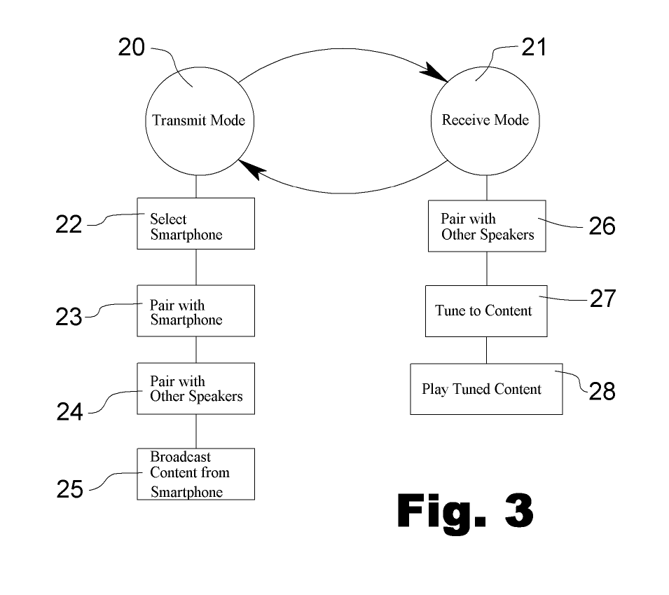

A speaker can be in one of two modes, a transmit mode 20 and a receive mode 21 as shown in FIG. 3. The user can toggle the speaker between these two modes. When a speaker is in the receive mode 21, its controls can be used to select content, control volume and perform other manipulations on the receive content or the sound being produces. In the transmit mode 20, the speaker can be paired with a smartphone and can be placed in a state where it broadcasts audio content from the smartphone to other speakers.

There are many ways a network can be configured both at a physical and link level and at higher protocol levels. The chart in FIG. 3 assumes a pairing link layer protocol such as BLUETOOTH™. In FIG. 3, at the link level, all speakers pair with all other speakers in range. Transmit mode speakers pair with selected smartphones. It is optional whether the smartphones pair with one-another. Typically, this is not necessary. At a higher level, various functions occur as shown in the rectangular boxes in FIG. 3. In transmit mode 20, a speaker can be caused to select 22 and to pair 23 with a particular smartphone. The speaker pairs with all other speakers in range 24. It then commences to stream content from the smartphone and to pair with other speakers 25. The original source of the content can be controlled from the smartphone. In receive mode 21, a speaker pairs with all other speakers in range 26. A user then selects or “tunes” content 27 from any broadcasting speaker in range. Finally, the speaker plays the selected content 28.

It should be noted that there are logical connections between broadcasting speakers and receiving speakers tuned in. These logical connections are created in a higher layer in the protocol stack that is above the link layer pairing.

FIG. 3 and the above description applies to a BLUETOOTH™ type link layer. However, any other type of physical or link layers are possible and within the scope of the present invention. The logical layer however, remains the same in most cases. In particular, WiFi links, Zigbee and any other types of wireless links may be used and are within the scope of the present invention.

### Button Control

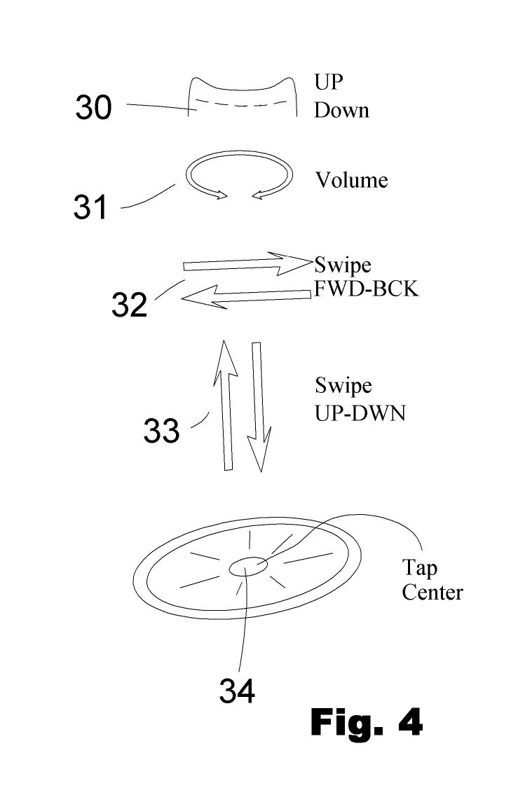

FIG. 4 shows a wireless speaker device with a control button or broadcast dial. In this embodiment the broadcast dial can be a touch sensor mounted on a mechanical button. The button has an up and down position 30. It can respond to a circular motion 31 and two swipes: Forward-Back 32 and UP-Down 33. It can also respond to a center tap 34.

### Button-Up Position

The button-up position is the normal operating configuration for the speaker. In the button-up position, several gestures are available to users to control the speaker. Some of these gestures are universal:

volume—swipe clockwise/counter clockwise around circumference of button

next, back-swipe—swipe fwd/back

These two gestures work in the same matter regardless of the button position (up or down). Some of the gestures may have different functions depending on position of the button position, but are intended to have analogous functions intended to make the control intuitive and easy to remember:

Swipe up/down

Tap in center

In the button-up position, swipe up and down can be used to select among available phone sources. This can be used when multiple smartphones are supplying content into the network. Also, in the button-up position a tap in the center can allow the device to toggle a phone-speaker connection lock function. This locks the particular speaker to a particular smartphone.

### Button-Down Position

The button-down position can be used to configure the speaker in the network. This is the network control position, or intra-speaker network mode. In this position, vertical up/down motion selects the source of content, and fwd/back motion allows control of a broadcast. A tap can be used to unlock or locked broadcast.

To initiate the intra-speaker network connection, the mechanical button is depressed into the button down position. Once depressed a “signature” LED signal initiates to signal that the speaker is in the control configuration, pulsing green for example. If the speaker was already connected to a smartphone, then by default, depressing the button places the speaker in a transmit mode where it transmits content from its smartphone to other speakers, and is locked as such, with a locked icon illuminated to illustrate that status. If the speaker had not previously been connected to a smartphone, then by default, the speaker is placed in a receiving mode where it can receive content from other speakers. Receiving and transmitting modes can be designated by visual cues such as the illumination of a broadcasting icon when in broadcast mode.

A second speaker can subsequently also be placed in the button-down intra-speaker network mode. It, just like the first speaker, is placed by default into locked broadcast mode if it presently is connected to a smartphone. If the user wishes to join an existing broadcast from another speaker however, the user swipes up and down to place the speaker in receiving mode and tune the speaker to other broadcasts, such as the pulsing green broadcast of the first speaker. As noted above, the vertical, up/down swipe motion has a different function when the button is up (phone-speaker connection mode) and down (intra speaker connection mode) the nature of both functions is to tune the speaker into an audio source, thereby forming an analogy that assists users in remembering the actions associated with the vertical swipes.

### Locking and Unlocking the Intra-Speaker Network

One scenario which is addressed by the present invention is the case where two devices are connected allowing two friends to connect devices at the gym, on the train ride home, or in some other situation. This scenario is likely to be the most common scenario among headphone shared audio, namely a small handful of users connecting in a peer, dynamic manner.

It is desirable that instead of a fixed broadcast vs. a receiver mode that the broadcasting and receiving switches between the two users as they take turns selecting and controlling the music. One simple mechanism for accomplishing this is that one speaker initiates transmit or broadcast mode simply by the user playing audio. The broadcasting speaker can then signal to the other headphone on the intra-speaker network that it has now switched to receiving mode. The receiving speaker can then send a signal to the smartphone to pause the audio stream it was previously playing. If the receiving user then decided to resume playing music, the above procedure would reverse causing the other user's speaker to become the receiver and for the audio to be automatically paused. This technique provides a simple way to coordinate the passing of control back and forth between two users. In addition, it may be desirable that in this scenario both users have control over song controls, such as play/pause and fwd/back. This scenario mirrors that of two people in the front seat of a car, both with access to the controls. This is the unlocked mode of the intra-speaker network

An alternative scenario is where one “DJ” is providing an audio stream for a number of receivers. In this scenario, having a single user maintain control of the audio is desirable. Therefore the present invention gives the broadcaster the option to keep their broadcast fixed to their stream, and to not allow other receivers to seize control. This is the locked mode of the intra-speaker network. Such lock/unlock controls would likely be augmented with configurations on a smartphone App that would allow the device to have more lock control options such as allowing one additional user to control the stream, but no one else.

If the second speaker user wishes to have more control of a locked intra speaker network, three options are available. First, they can ask the first speaker owner to tap the button and unlock the broadcast, thereby allowing the second user to participate in controlling the broadcast using fwd/back and also to seize control of the broadcast as described above

Second, the user of the 2^{nd} speaker may start their own broadcast. To do this, the user resets the connection by releasing the broadcast button and connects their smartphone to the second speaker (if they had not already done so) and reinitiate the button press thereby putting their speaker into transmit mode waiting for others to join their broadcast. The third option is simply to place the button in the up position and listen to their own music from their own smartphone without joining the intra-speaker network at all.

This electronic button embodiment has the advantage of being more easily controlled by a remote source (such as another speaker or phone) which could change the mode of the speaker (from broadcast to receiving) without having to actuate a mechanical change.

In fact, it should be appreciated that an additional “soft” or non mechanical button could be added to eliminate the mechanical switch altogether. Such an embodiment would allow a remote device (such as the smartphone) to initiate a transition from phone-speaker connectivity to intra speaker connectivity without having to effect a mechanical button's movement.

### Mechanical Dial Control

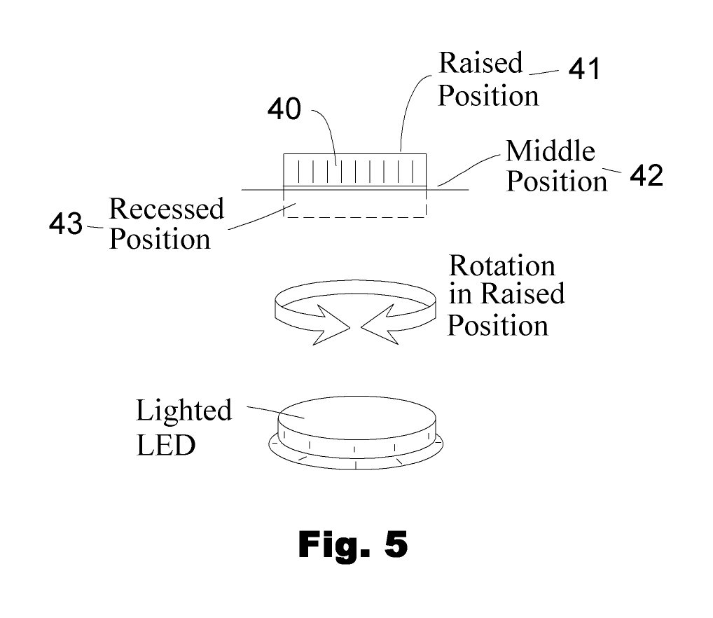

In another embodiment shown in FIG. 5, a totally mechanical dial is used. This eliminates the need for a sensor. In this embodiment, the interface comprises a 3-position button and dial 40. If the button is in the middle position 42 (in this case shown as flat or flush with the body of the housing), the device is in the normal pairing mode (phone-speaker connection) with no intra-speaker connections. A typical pairing sequence would be that the speaker is in pairing mode (either the speaker is by default in pairing mode or explicitly put in such mode by the user), the local device (smartphone or tablet) selects the device for pairing, and the two are subsequently paired and can connect either automatically when brought into proximity or manually by user selection.

When the button is in the recessed (down position) 43, the device is in the “broadcast” or transmit mode. In this mode, several things happen
1. The transmitting speaker initiates the connection with the intra-speaker network (if on exists).
2. The transmitting speaker maintains the connection with the smartphone and continues to play audio streamed from the smartphone.
3. The transmitting speaker makes the audio stream available to the intra-speaker network.
4. The transmitting speaker device signals with a multi colored LED that it is in transmitting mode and is broadcasting.
5. The multi colored LED pattern can be modified by rotating the dial while in transmit mode.

Embedded in the transmitting speaker signal is a user name, which by default is the name of the smartphone as used by BLUETOOTH™ or other communication method to identify it.

At this point, it is possible (because there is something to receive) for another speaker device to join the intra-speaker network as a receiver by putting its button into the third position, the raised (up) position 41, which initiates several actions on the receiving speaker.
1. The receiving speaker device the connection with the intra-speaker network.
2. The receiving speaker may maintain the connection with the smartphone (if there is one), but discontinues playing audio streamed from that smartphone.
3. The receiving speaker receives an audio stream available to the intra-speaker network.
4. The receiving speaker signals with a multi colored LED that it is synchronized (synced) with the transmitting speaker. This indicates visually that the second speaker has joined the intra-speaker network, is listening to that particular broadcast stream, and is furthermore available to rebroadcast that stream. It should be appreciated that such LED signals can always be turned off at the user's discretion.

If there is more than one transmitting device in the proximity, the dial on the three position button on the second speaker can be turned to choose between the various transmitting streams. As each stream is “tuned to” a given transmitter, visual and audio cues can be given that help to identify the transmitter. For example, the LED pulses in an identifiable pattern based on the transmitter. As an alternative, or in addition to the visual cue, an audio cue may be a text to speech sound based on the user name of the transmitter.

Neither of the above-described buttons provide comprehensive control over the speaker or the broadcast, but rather provide basic functions to allow control and the easy connection of speakers without requiring the use of an App. More advanced functions such a configuration of the LED patterns and the like can be accomplished using a smartphone App.

### LED Visual Signals

The multi colored LED signals on the speaker and headphone devices serve several purposes: First, they assist the user in identifying when open intra-speaker networks are available. For example, consider an ad hoc assembled group of people in a public space who wish to listen to the dialog of a speaker or to enjoy music being broadcast from a user's smartphone. Simply by seeing the familiar pulse of an LED in a familiar shape, those users could know that a stream is available for connecting to.

Second, they assist in distinguishing different “broadcasts” or “stations” within that proximate area. One can imagine an assembly of headphone wearing users assembling in a common area such as a coffee shop or gym. Those users may wish to choose from among a number of different sources. Such sources might be emanating from different televisions or such signals may be associated with different genres or sources of music. In either case, it would be useful for a listener to be able to see at a glance with the turn of a dial to which station they are tuned.

Third, the LED signal of receivers would also signal which other listeners are tuned in to that particular station. This might be particularly useful in cases of silent dance parties where it would be highly desirable to be dancing to the same music as others in the immediate vicinity. Listening to the same spoken word could also be desirable in a variety of cases where a shared experience would be desired by some of the people assembled in an area.

Fourth, an LED allows individual user customization through the selection of a timed color pattern. For example, consider that a device's default broadcast pattern (set at the factory) is a slow pulsing green pattern. Such a signal could become, over time, associated with (in combination with the familiar shape) the invention herein described. Alternative color patterns can also be associated with a particular user, giving them a uniquely identifiable pattern or even a source of audio. For example, those broadcasting American patriotic music could use a red white and blue pattern. It goes without saying that a series of red white and blue pulses would not, by themselves uniquely be identified with the US flag, but over time such associations could be formed.

A set of such patterns could be included on the device itself such that users would naturally have non conflicting patterns chosen for them by the device in response to the intra-device network situation. For example, the first user to initiate broadcasting would use a pattern either chosen by the user or randomly presented to them, such as the pulsing green pattern. The second users in the same intra-device network would use a pulsing red pattern, the third pulsing blue and so on. Users would be allowed to customize their own patterns, likely using a smartphone App, thereby automatically having a pattern of their own (and one less likely to be duplicated by another user on the intra device network.) A central server could even allow customized patterns to be browsed and downloaded.

Such patterns could even be mirrored by a skin for the headphone/speaker that is coordinated with the sound and or LED signal. Ie a union jack themed skin that is paired with an LED signal that is blue and red. Alternately, nautical flag type signals as skins that designate the LED patterns.

It should be appreciated that while audio of visual cues such as the LED patterns mentioned here are visual indicators of a broadcast, the broadcast would itself have a unique identifier that would eliminate actual conflicts on the intra-speaker network. In other words, while it's easily conceivable that two broadcasters would come into proximity having the same LED pattern, they would actually have different unique identifiers. While user confusion could arise from the fact that two broadcasts share the same LED pattern, such a conflict could either be ignored by users: “Just choose the second blinking green pattern, that's Jimmy”, or by the user changing their pattern to avoid confusion. In either case, the two broadcasts would not cause an actual conflict on the network, but rather simply a duplicate use of the LED pattern.

A particular aspect of the present invention is that the visual signal can be of a shape that users can associate with the available connection. Such a visual indicator (in the form of light guide illuminated by a series of LEDs) in the shape of a logo or icon can provide continuity designating the technology behind the broadcast even as the colors and nature of the pulsing lights vary from user to user. In other words if a stylized Q was used as a unique shape, the pulsing Q of various color patterns could become a familiar symbol of the technology, providing known compatibility.

### Audio Signal

It should be noted that an audio signal (either in addition to or as a substitute for a visual signal described above) is also desirable. In headphone applications, the headphone is typically situated on the head in such a way that it is not visible to the person wearing it, but it is, of course able to be heard. A user dialing through network streams, much like a user dialing through stations on an FM radio, is likely to listen to the audio emanating from each stream and choose the one playing the music they prefer, or the audio that matches with the video they are viewing (as in tuning a video channel from a number in view). However, there are some cases where a unique audio identifier would facilitate a connection. For example, a silent disco with more than one DJ available might make a unique identifier desirable. Such a unique identifier could be the DJ's username that would be played to the listener as they scrolled through the potential selections. Each DJ could post their username in a visible place, as is often done to provide users with the login credentials for a WiFi access point or the like.

### Combined Visual and Audio Signals

There are numerous ways a set of visual and audio cues can be synchronized and combined. Among these is the combination of a prescribed visual pattern like the slowly pulsing green light for example, and synchronizing that with the music being played such that the intensity of the light matches the volume of the music. Such visual “beat matching” is often done automatically by lights that react to the rhythm of music. Such a scheme has the advantage of being automatically generated and yet still uniquely identifiable. In the silent DJ example, it is easy to imagine that a pulsing pattern synchronized with DJ's audio could facilitate the identification of that signal, because such a pulse is easily identified with the audio that it is in synchronization with. Synchronizing the pulse of the visual signal with the audio would also have the effect of making the listening experience more enjoyable.

There may be cases where broadcaster selection could be augmented by a phone or tablet application which would allow users to scroll through a list of usernames that could even be augmented by additional profile information, thereby linking a physical and virtual connection to the broadcaster. One can imagine that a DJ powering a silent disco might want additional contact information to be available about them to facilitate a subsequent virtual connection between them and listeners or even to facilitate a real time alternate channel of communication. As an example, A DJ may wish to accept requests by instant message or contributions via a payment gateway such as VENMO™ or PAYPAL™.

It should be appreciated that many of the features above would not be desired by all users and in many case it would be important to allow user control of the illumination of LEDs on their devices. It is easy to imagine cases where the user would wish privacy over the content of their listening or simply not want the disruption of that illumination (as in a darkened room where a partner is sleeping).

### Private (Locked) Connections

It is also important that private connections be allowed. So for example, a common use case of a shared audio stream is for two friends to be able to share a music playlist on a bus or train or while exercising. In this case, it would be advantageous for the broadcasting user to be able to allow the friend to connect to their speaker (headphones) while suppressing the ability of other users to connect to the device. One method to allow such a mechanism would be to simply open the connection for a limited duration of time, say 10 seconds, which would allow the two friends to coordinate to connect within that window, but would close the connection after that time thereby preventing others from subsequently connecting. The LED display would shut off after the 10 second open period, thereby preventing others from interpreting the signal as open. The display should be associated with an available connection, and while there may be cases where an available connection is not accompanied by a visual indication of such, the visual indication (the display) should never be present without an accompanying available connection.

Another method that would restrict intra-speaker connections to those specifically designated is to use a close proximity sensor such as a Near Field Connection (NFC) which typically restricts activity to a range of a few inches. In some cases this “pairing” is restricted to actual contact in a designated way to activate. By tightly restricting such pairing in such a way and requiring two users to actually touch their devices to one another (or at least bring their devices into extremely close proximity), it would prevent the uninvited from connecting. In many cases, a secondary step of confirmation is required to pair with a device after proximity with an NFC sensor prompts the user. Such confirmation prevents unintentional pairing, and a similar function could be achieved by having the user set the 3-position button into the appropriate position before bringing the speaker devices into proximity.

Another method of allowing private connections is to have a separate lock and unlock button that governs the state of the three position dial described above.

Finally, another method is that such connections could be controlled by an App on the connected smartphone that could determine if connection was locked (private) or unlocked (public), and/or which other devices would be allowed to connect to the broadcasting device.

In any case, a setting that toggles between open and closed pairing is desirable to allow users control over their pairing mode. Users unconcerned about the privacy of the connection would receive the benefit of an open connection, while users wishing to have more control over the connection would be afforded the ability to be more selective about which users they pair with. Such a setting could be controlled with the use of a physical button designated by the familiar lock/unlock icons or done through some other configuration means such as a setting within a phone application. Although not required, simplicity would dictate that such a lock control would simultaneous lock the phone device connection as well as the intra-speaker control.

### Advanced Controls

Finally, while it is an object of this invention to allow as much control as possible solely using the controls on the speaker device itself, there is no reason that more advanced controls cannot be available on an App that controls and configures the speaker.

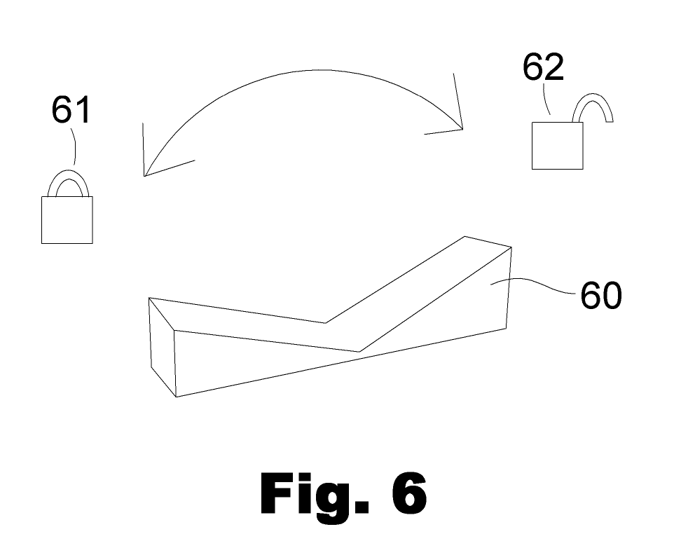

Given that different users have different preferences and situations, a separate button or switch on the speaker (headset) may be useful to allow the user to control the phone-speaker connection. Such a switch 60 is shown in FIG. 6, The switch has a locked 61 and an unlocked 62 position.

For example, some users may wish to leave the speaker in a constant “open” pairing mode to facilitate the connection of various users in the home to connect their devices, the default behavior in this state is to disconnect the previously connected user when the new user connects. This allows simultaneous connections. Other users may wish to retain more control, and place the speaker in a “locked” pairing mode after pairing with a paired device, having that device being the only device allowed to connect with the speaker. In other cases, where the speaker is only intended to be connected to the intra-speaker network, it may be desirable that the phone-speaker connection be turned off entirely to avoid inadvertent connections.

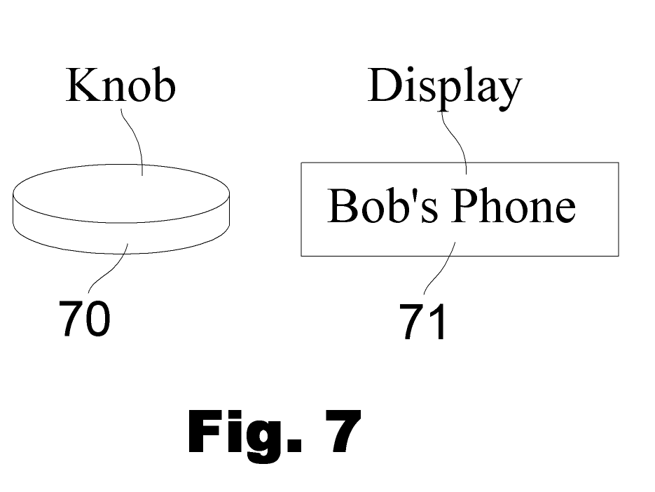

In an alternative embodiment, it can be desirable that a dial or knob 70 would turn through the various phones available for connecting as shown in FIG. 7. A display 71 can show where the device is tuned.

Typically the list of phones available for connecting are those devices that have already paired with the device and given authorization to the speaker to initiate a subsequent automatic connection. This is particularly useful in cases where an automatic connection from the speaker to the phone is desired, but where multiple candidate phones are available. In such a situation, a dial on a speaker that either displays the name of the phone, or through text to speech technology, the name of the phone could be audibly pronounced through the speaker. Of course, in scrolling through a list of available phones, the process is no longer truly “automatic” but nonetheless considerably easier than having to manipulate an App on the phone to determine the connecting device. Such a dial as described above could be combined with the three position dial previously described. In the position where the device is in the “normal pairing” mode (phone speaker mode), the dial can be used to select phone sources instead of speaker sources when in intra-speaker receiving mode.

### Multi-Room Systems

Much of the preceeding has focused on synchronized listening where a group of users are anticipated to be listening to the same audio in a single “area” although the area may well be quite large as in the case of a large group gathering. However, a second use case is distinct from this scenario, namely the use of a group of connected speakers in a multi room home. Unlike the group listening setting above, it cannot safely be presumed that it will be desired that a single stream will be playing throughout the intra speaker network.

Much of the expected behavior of the speakers in a multi room scenario would mirror that of other multi speaker scenarios. Namely, a host speaker is put into transmit or broadcast mode, and when the user wants that same audio playing from other speakers, they are put into receiving mode and tuned to the broadcasting speaker.

In the case of the multi room audio scenario however, it would not be uncommon that a single source of audio (a smartphone or tablet) being highly portable may travel throughout the home, coming into contact with a variety of speakers all owned and controlled by one user. In some cases the phone might travel to a second speaker and outside the range of the original “broadcasting” speaker. In cases where the signal power of the intra-speaker network is greater than the phone-speaker connection, the second speaker could automatically act as a silent repeater. If the phone speaker connection was BLUETOOTH™, such a handoff could occur automatically with the second speaker signaling to the original speaker to drop the phone connection, thereby allowing the 2nd speaker to connect with the phone thereby rebroadcasting the signal to the original broadcasting speaker with or without the second speaker playing music. If the user does wish for the second speaker to play music, there are several options to initiate this from a user interface perspective. First, the user could set the speaker to receive mode, and tune it to the original broadcasting speaker. Although the second speaker is, in fact, itself receiving and repeating the signal, the detailed workings of the intra-speaker network have been obscured from the user, for the user, it likely seems that the second speaker is simply tuning to the original broadcast. A third speaker, already configured to be a part of the intra-speaker network, could play audio using the same mechanism of setting the speaker to receive mode (regardless of proximity to the phone) and begin playing the same audio once tuned to the broadcasting speaker (through the intra speaker network). At the end of the evening, the party ended, the user goes to the bedroom to retire. The user could now put the second speaker into regular pairing mode, thus disconnecting the previously broadcasting speaker (and all the speakers tuned to it). As an alternative, the user could put the second speaker into broadcast mode whereby the other receiving speakers that were previously receiving their audio stream from the original broadcasting speaker are now receiving their broadcast signal from the second speaker. This would not change the audio playing from the 1^{st} speaker, but it would give control to the second speaker. Finally the user could simply “turn off” the second speaker, returning to the state when it was silently repeating the broadcast and leaving the audio playing in the living room for a few stragglers who remain in the living room.

In all these multi-room scenarios, the speakers would have to be configured by the user to give permissions for such automatic connections and handoffs, the details of the permissions behind phone-speaker connections is well known for example in BLUETOOTH™. In addition, it would be advantageous to allow speakers to be configured to have a “forget” mode so that they are not inadvertently left at high volume in receive mode only to subsequently blast the user when a broadcast speaker is unintentionally tuned to that pattern.

In an alternate embodiment with multiple smartphones, the smartphones, using an application, can provide an additional level of robustness to the network by coordinating and providing for each other a fallback source of audio. If the smartphone providing the intra-speaker network is streaming using a streaming source accessible to other phones in the network (such as a shared playlist on an Internet music streaming source), it is advantageous for the application to share the source and time location of the source stream to the other smartphones connected to the intra-speaker network so that they can be synchronized as they play audio and in the case that the first smartphone loses connectivity, either to the audio source or the intra-speaker network, the second smartphone can seamlessly step in and replace the audio stream.

### SUMMARY

The nature of the intra-speaker network as it has been described here is that audio is supplied to a network by devices that are typically portable devices, most commonly mobile smartphones. It is typically the nature of these devices to be vulnerable to disconnections owning the the device holder leaving the range of the intra-speaker network or running out of battery power, or the like. An additional aspect of the intra-speaker network is that multiple smartphones can be connected to multiple speakers comprising the network.

Several descriptions and illustrations have been presented to aid in understanding the present invention. One with skill in the art will realize that numerous changes and variations are possible without departing from the spirit of the invention. Each of these changes and variations is within the scope of the present invention.

1. A sound delivery system comprising:
a speaker device being capable of converting electrical signals into audible sound and capable of wireless communication;
the speaker device having two modes selectable by a user, a transmit mode and a receive mode;
the speaker device in the transmit mode configured to stream audio content wirelessly directly from a smartphone, convert it to audible sound, and wirelessly broadcast said content directly to a plurality of other similar speaker devices;
the speaker device in receive mode configured to receive said audio content directly from another similar speaker device and to convert said content to audible sound;
wherein said speaker device has an attached button, the button having a first and second postion, the first postion placing the speaker in receive mode, and the second position placing the speaker in transmit mode; and,
wherein said button contains a sensor configured to sense gestures, wherein said gestures control audio volume and content selection by selecting between content broadcast by a plurality of similar speaker devices;
and wherein, a visual cue on the speaker that indicates a particular audio content being broadcast or received, the visual cue being customizable by a user.

2-3. (canceled)

4. The sound delivery system of claim 1 wherein said gestures control audio volume and content selection by selecting between content broadcast by a plurality of similar speaker devices.

5. The sound delivery system of claim 1 wherein said gestures control pairing to another similar speaker device.

6. The sound delivery system of claim 1 wherein a first of said similar speaker devices broadcasts audio content from a smartphone, a second of said similar speaker devices acts as a rely rebroadcasing said audio content to a third of said similar speaker devices that converts the content to audible sound.

7. The sound delivery system of claim 6 wherein the first and second similar speaker devices also convert said content to audible sound.

8-9. (canceled)

10. The sound delivery system of claim 1 further comprising an audio cue from the speaker that indicates a particular audio content being broadcast or received.

11. The sound delivery system of claim 10 wherein the audio cue is customizable by a user.

12. The sound delivery system of claim 1 wherein said speaker device is a loudspeaker.

13. The sound delivery system of claim 1 wherein said speaker device is a headphone.

14. A sound delivery system comprising:
a plurality of similar speaker devices each configured to convert electrical signals representing audio content into audible sound;
each similar speaker device capable of wireless communication with a smartphone and capable of wireless communuication with another similar speaker device;
said plurality of similar speaker devices forming a peer-to-peer wireless communication network, wherein some of said plurality of speaker devices are in a transmit mode and stream different audio contents 1, 2, 3, . . . N from a plurality of N smartphones, and broadcast these audio contents on the network as audio contents 1, 2, 3, . . . N, while others of said plurality of speaker devices are in a receive mode and produce audible sound, in each case, taken from a choice of one of audio contents 1, 2, 3, . . . N, where N is a positive integer greater than one, wherein, the speaker devices in receive mode have one or more controls that allow each of the speakers in receive mode to select one of the audio contents 1,2, 3, . . . N.

15. The sound delivery system of claim 14 wherein some of those speakers in transmit mode also convert the particular audio content they are streaming from a particular smartphone to audible sound.

16. The sound delivery system of claim 14 wherein some of those speakers in transmit mode also convert particular audio content received from another speaker in transmit mode to audible sound.

17. The sound delivery system of claim 14 wherein a handoff occurs between a first broadcasting speaker and a second broadcasting speaker as a smartphone moves out of range of the first broadcasting speaker and into range of the second broadcasting speaker.
